(19) United States
(12) Patent Application Publication
(10) Pub. No.: US 2005/0262033 A1
(43) Pub. Date: Nov. 24, 2005

(54) Data recording apparatus, data recording method, program for implementing the method, and program recording medium

(76) Inventor: Kazuhiko Yamashita, Soraku-gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/397,290

(22) Filed: Mar. 27, 2003

(30) Foreign Application Priority Data
Mar. 29, 2002 (JP) 2002-096462

(51) Int. Cl. G06F 7/00

(52) U.S. Cl. 707/1

(57) ABSTRACT

The present invention provides a data recording apparatus which allows data to be read on the next access after recording of cluster data or a file index is interrupted by power disconnection or the like caused during a data updating process. A cluster data processing section 14 searches a cluster region 112 of a recording medium 11 for an empty cluster and records cluster data into the empty cluster. A reserve file index processing section 16 creates anew reserve file index for the recorded cluster data within the index region 111 of the recording medium 11. Then, a regular file index processing section 15 updates the contents of an existing regular file index corresponding to update data to the contents of the reserve file index. Thereafter, the reserve file index processing section 16 deletes the reserve file index from the index region 111.

### BACKGROUND OF THE INVENTION

1. Field of the Invention

The present invention relates to a data recording apparatus, a data recording method, a program for implementing the same method, and a program recording medium, and more particularly to a data updating technology which provides a data recording apparatus and a data recording method used for recording data to a recording medium, such as a semiconductor memory, a magnetic disc, and a magneto-optical disc, in a file system where the data recorded in the recording medium is managed in a file format.

2. Description of the Background Art

In an information apparatus, such as a personal computer, a digital video recording apparatus, and a game apparatus, a file system in which data is managed in a file format is generally used for recording/reading data to/from a recording medium such as a hard disk. In a typical file system, data is managed as cluster data in a prescribed unit of a cluster (equivalent to, for example, 512 bytes) or data is divided and managed as a plurality of cluster data in prescribed units of clusters. In such a system, the cluster data is recorded into an empty region in a recording medium and managed by using a prescribed file index. The file index is created for each data, i.e., a file, recorded in the recording medium, and describes information about a file attribute, locations at which cluster data are recorded, the order of the cluster data, etc.

A concept of a conventional file system using the file index is described with reference to FIGS. 6 and 7. An example of the conventional file system using the file index is described in A. S. Tanenbaum et al., “Operating Systems: Design and Implementation, Second Edition”, Pearson Education.

FIG. 6 is a functional block diagram of a conventional data recording apparatus for performing data recording in the conventional file system. FIG. 7 is a diagram illustrating an example of a recording structure within a recording medium 61 illustrated in FIG. 6.

In FIG. 6, the conventional data recording apparatus includes the recording medium 61, a data processing section 62, a working memory 63, a cluster data processing section 64, and a file index processing section 65.

The recording medium 61 is, for example, a hard disk, a DVD-RAM, or the like. As illustrated in FIG. 6, the recording medium 61 includes an index region 611 to which file indices are recorded, and a cluster region 612 to which cluster data presegmented in units of clusters are recorded. As illustrated in FIG. 7, each file index holds in a table format a file name, file attribute information, and cluster arrangement information indicating cluster locations (e.g., addresses) within the recording medium 61 at which cluster data included in a file are recorded and the order of the cluster data.

A process for recording new data to the recording medium 61 will now be described.

Upon receipt of data to be recorded to the recording medium 61, the data processing section 62 stores the data as one cluster data in a unit of a cluster into the working memory 63 or divides the data into a plurality of cluster data in units of clusters and stores the plurality of cluster data into the working memory 63. When the one cluster data/the plurality of cluster data is/are stored in the working memory 63, the cluster data processing section 64 searches the cluster region 612 of the recording medium 61 and extracts an empty cluster therefrom. Next, the cluster data processing section 64 reads the cluster data from the working memory 63 and sequentially records the read cluster data into the empty cluster extracted from the recording medium 61. When recording of all the cluster data is completed, the file index processing section 65 creates a new file index within the index region 611 of the recording medium 61, and describes, as cluster arrangement information, information about respective locations at which the cluster data are recorded and the order of the cluster data.

A file index illustrated in FIG. 7 indicates that: four cluster data C1 to C4 are included in a file; first cluster data C1 is recorded in cluster 1001 within the recording medium 61; second cluster data C2 is recorded in cluster 1002 within the recording medium 61; third cluster data C3 is recorded in cluster 1004 within the recording medium 61; and fourth cluster data C4 is recorded in cluster 1006 within the recording medium 61.

Next, a process for updating data, which is already recorded in the recording medium 61, by addition or overwriting will be described.

In the case of adding new data, the cluster data processing section 64 records cluster data C5 (not shown) to be added, which is stored into the working memory 63 via the data processing section 62, to an empty cluster, e.g., cluster 1007, within the cluster region 612. The file index processing section 65 adds location information about cluster 1007, in which cluster data C5 is recorded, at the end of cluster arrangement information of a file index corresponding to a file to which the new data is added and updates the cluster arrangement information.

In the case of overwriting data with other data having the same size, the cluster data processing section 64 records cluster data C2′ (not shown) to be written over cluster data C2, which is stored into the working memory 63 via the data processing section 62, to cluster 1002 within the cluster region 612. In this case, no cluster arrangement information of any file index is rewritten.

In the case of overwriting data with other data having a different size, the cluster data processing section 64 records cluster data C2′ and C2″ (not shown) to be written over cluster data C2, which are stored into the working memory 63 via the data processing section 62, into cluster 1002 and an empty cluster, e.g., cluster 1007, within the cluster region 612. The file index processing section 65 updates cluster arrangement information of a file index corresponding to a file to which data is recorded by overwriting and addition, such that pieces of location information corresponding to clusters 1007, 1004, and 1006 are respectively listed third, fourth, and last.

In the case of reading data, which has been recorded to the recording medium 61 in a manner as described above, the file index processing section 65 searches the index region 611 by using a file name as a key and extracts a file index corresponding to the file name. Then, the file index processing section 65 recognizes that the data is recorded in clusters 1001, 1002, 1004, and 1006 in a divided manner by referencing cluster arrangement information of the extracted file index. The cluster data processing section 64 sequentially reads cluster data described in the cluster arrangement information from the first cluster and outputs cluster data C1 to C4.

However, the conventional data recording apparatus has the following problems about a data updating process.

Firstly, when there is a trouble caused by power disconnection or the like due to a power failure or a run-down battery during a process for recording cluster data to the cluster region 612, the process is interrupted before a recording operation is properly performed on cluster data to be updated. Thus, the file index of the cluster data can be properly read from the index region 611 on the next access after the trouble but neither post-updated data nor pre-updated data can be read from the cluster region 612.

Secondly, when there is a trouble caused by power disconnection or the like due to a power failure or a run-down battery during a process for updating a file index within the index region 611 after the recording of cluster data to the cluster region 612 is completed, the process is interrupted before the file index is properly updated. Thus, the file index cannot be properly read from the index region 611 on the next access after the trouble.

In order to solve these problems, a method (a redundant recording method) for recording an original file and a backup file, which has the same data contents as those of the original file, to a recording medium is conventionally used for each file recording operation. According to the redundant recording method, even when data for the original file is corrupted, it is possible to avoid the impossibility of data reproduction by reading the backup file.

In the redundant recording method, however, a backup file is recorded for each recorded file, and therefore, as compared to the conventional method, the capacity of the recording medium is inevitably consumed twice as much as another conventional method consumes. Moreover, in the redundant recording method, it is necessary to record the same data twice for each recording operation, and therefore twice as much time is required for recording onto the recording medium.

Further, in the redundant recording method, it is necessary to additionally perform a process for determining which one of the original file and the backup file should be read based on a recording state of the cluster data (i.e., based on whether the cluster data is normal or corrupted). Furthermore, in the redundant recording method, when one of two recorded files is corrupted, a normal file is required to be recorded so as to restore the corrupted file. Thus, needless time is required for such a restoring process.

### SUMMARY OF THE INVENTION

Therefore, an object of the present invention is to provide a data recording apparatus which, even when no files are backed up, allows data to be read on the next access after recording of cluster data or a file index is interrupted power disconnection or the like caused during a data updating process.

Another object of the present invention is to provide a data recording method which, even when no files are backed up, allows data to be read on the next access after recording of cluster data or a file index is interrupted by power disconnection or the like caused during a data updating process.

The present invention has the following features to attain the objects mentioned above.

A first aspect of the present invention is directed to a data recording apparatus for recording data to a recording medium by using a file containing one or more cluster data in prescribed recording units, and at least one file index in which at least a file name, and locations and an order of cluster data recorded on the recording medium are described.

The data recording apparatus according to the first aspect comprises: a cluster data recording processing section for recording the data into an empty region within the recording medium in units of the cluster data; a regular file index recording processing section for creating a file index for the data recorded by the cluster data recording processing section as a regular file index and recording the regular file index to the recording medium, the data being new data contained in a new file; a reserve file index recording processing section for creating another file index for the data recorded by the cluster data recording processing section as a reserve file index and recording the reserve file index to the recording medium, the data being update data for updating data contained in an existing file, a regular file index update processing section for searching, after the reserve file index is recorded by the reserve file index recording processing section, the recording medium for an existing regular file index having the same file name as that of the reserve file index, and updating contents of the regular file index, which has been searched for, to contents of the reserve file index; and a reserve file index delete processing section for deleting the reserve file index from the recording medium after the contents of the regular file index is updated by the regular file index update processing section.

As described above, according to the first aspect, post-updated cluster data and a reserve file index therefor are recorded at first, and thereafter the regular file index is updated. As a result of this, even if a trouble such as power disconnection is caused during a data updating process, it is possible to always keep consistency between the file index and cluster data, thereby avoiding a phenomenon in which data cannot be read. Further, the reserve file index is deleted after the regular file index is updated, and therefore it is possible to use a recording medium having a smaller capacity as compared to the conventional apparatus which redundantly records a backup file.

According to a second aspect based on the first aspect, the data recording apparatus further comprises: an index searching section for searching through the at least one file index recorded in the recording medium at a startup of the apparatus to detect whether or not the reserve file index is present; and a restoring process control section for instructing the regular file index update processing section to update the contents of the existing regular file index to the contents of the reserve file index based on a determination by the index searching section that the reserve file index is present, and thereafter instructing the reserve file index delete processing section to delete the reserve file index.

As described above, according to the second aspect, a process for restoring a file index which is in a specific state is implemented after trouble recovery. As a result of this, even if a trouble such as power disconnection is caused during a data updating process, it is possible to always keep consistency between the file index and cluster data, thereby avoiding a phenomenon in which data cannot be read. Further, the file index restoring process only includes up to two steps, i.e., the step of creating or updating a regular file index and the step of deleting a reserve file index, and therefore it is possible to quickly restore a file index.

A third aspect of the present invention is directed to a data recording method for recording data to a recording medium by using a file containing one or more cluster data in prescribed recording units, and at least one file index in which at least a file name, and locations and an order of cluster data recorded on the recording medium are described. A fifth aspect of the present invention is directed to a program for allowing the data recording apparatus to implement the method of the third aspect. A seventh aspect of the present invention is directed to a recording medium having the same program recorded therein.

Each of the data recording method of the third aspect, the program of the fifth aspect, and the recording medium of the seventh aspect comprises: a first recording step of recording the data into an empty region within the recording medium in units of the cluster data; a second recording step of creating a file index for the data recorded to the recording medium at the first recording step as a regular file index and recording the regular file index to the recording medium, the data being new data contained in a new file; a third recording step of creating another file index for the data recorded to the recording medium at the first recording step as a reserve file index and recording the reserve file index to the recording medium, the data being update data for updating data contained in an existing file, a first updating step of searching, after the third recording step, the recording medium for an existing regular file index having the same file name as that of the reserve file index, and updating contents of the regular file index, which has been searched for, to contents of the reserve file index; and a first deleting step of deleting the reserve file index from the recording medium after the first updating step.

As described above, according to each of the third, fifth, and seventh aspects, post-updated cluster data and a reserve file index therefor are recorded at first, and thereafter the regular file index is updated. As a result of this, even if a trouble such as power disconnection is caused during a data updating process, it is possible to always keep consistency between the file index and cluster data, thereby avoiding a phenomenon in which data cannot be read. Further, the reserve file index is deleted after the regular file index is updated, and therefore it is possible to use a recording medium having a smaller capacity as compared to the conventional apparatus which redundantly records a backup file.

Each of a data recording method according to a fourth aspect based on the third aspect, a program according to a sixth aspect based on the fifth aspect, and a recording medium according to an eighth aspect based on the seventh aspect further comprises: a detecting step of searching through the at least one file index recorded in the recording medium at the beginning of the method to detect whether or not the reserve file index is present; a second updating step of updating the contents of the existing regular file index to the contents of the reserve file index based on a determination by the detecting step that the reserve file index is present; and a second deleting step of deleting the reserve file index from the recording medium after the second updating step.

As described above, according to each of the fourth, sixth, and eighth aspects, a process for restoring a file index which is in a specific state is implemented after trouble recovery. As a result of this, even if a trouble such as power disconnection is caused during a data updating process, it is possible to always keep consistency between the file index and cluster data, thereby avoiding a phenomenon in which data cannot be read. Further, the file index restoring process only includes up to two steps, i.e., the step of creating or updating a regular file index and the step of deleting a reserve file index, and therefore it is possible to quickly restore a file index.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of a data recording apparatus according to an embodiment of the present invention;

FIG. 2 is a flowchart illustrating a procedure of a process for updating cluster data and a file index;

FIG. 3 is a diagram illustrating a specific example of the procedure of the updating process of FIG. 2;

FIG. 4 is a diagram illustrating another specific example of the procedure of the updating process of FIG. 2;

FIG. 5 is a flowchart illustrating a procedure of a process for restoring a file index;

FIG. 6 is a functional block diagram of a conventional data recording apparatus; and

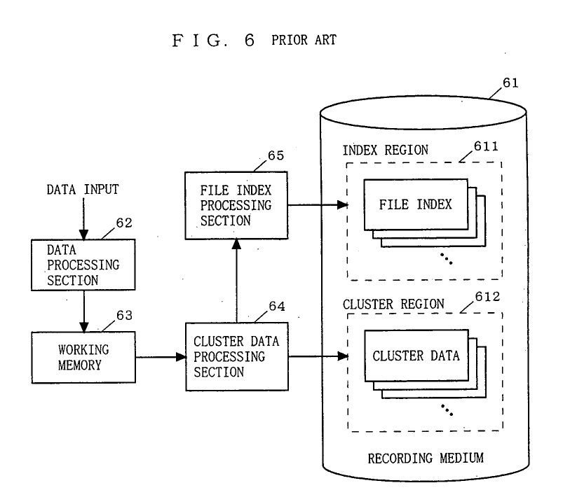

FIG. 7 is a diagram illustrating an example of a recording structure within a conventional recording medium or a recording medium of the present invention.

### DESCRIPTION OF THE PREFERRED EMBODIMENTS

Hereinafter, embodiments of the present invention will be described with reference to the accompanying drawings.

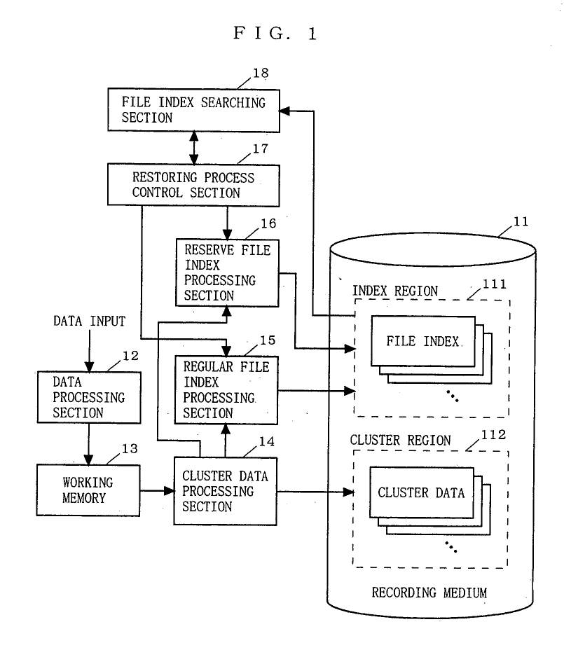

FIG. 1 is a functional block diagram of a data recording apparatus according to an embodiment of the present invention for performing data recording in a file system. In FIG. 1, the data recording apparatus according to the present embodiment includes a recording medium 11, a data processing section 12, a working memory 13, a cluster data processing section 14, a regular file index processing section 15, a reserve file index processing section 16, a restoring process control section 17, and a file index searching section 18.

Typically, the data processing section 12, the cluster data processing section 14, the regular file index processing section 15, the reserve file index processing section 16, the restoring process control section 17, and the file index searching section 18 are realized by a CPU and a ROM having a prescribed processing program stored therein. Processing as described below is realized when the CPU implements the processing program stored in the ROM. Typically, the working memory 13 is a RAM. The CPU, the ROM, and the RAM are connected to each other via a bus.

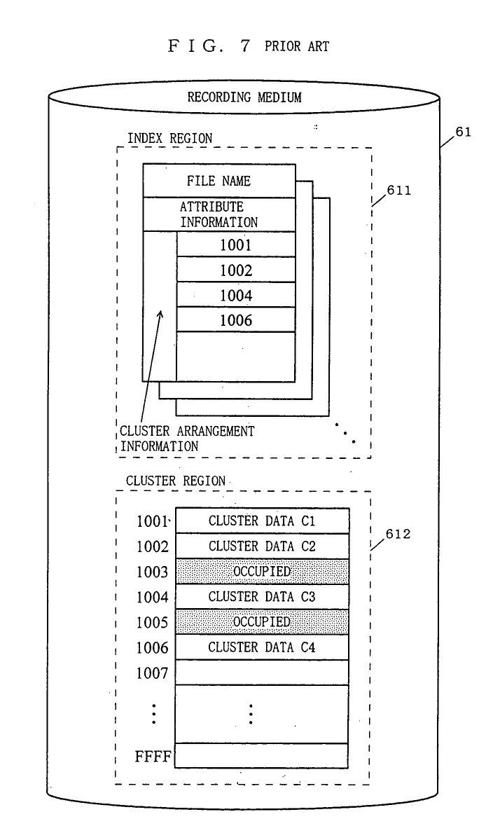

The recording medium 11 is, for example, a hard disk, a DVD-RAM, or the like. As illustrated in FIG. 1, the recording medium 11 includes an index region 111 to which file indices are recorded, and a cluster region 112 to which cluster data presegmented in units of clusters are recorded. File indices recorded in the index region 111 are functionally classified into two types. A first type includes a file index which is created during data recording and referenced for a normal file access. A second type includes a file index which is temporarily created. during a data updating process. In the following description, the former and the latter are distinguishedly referred to as a regular file index and a reserve file index, respectively. As illustrated in FIG. 7, each file index holds in a table format a file name, file attribute information, and cluster arrangement information indicating cluster locations within the recording medium 11 at which cluster data included in a file are recorded and the order of the cluster data.

In the data recording apparatus according to the present embodiment having the above-described configuration, similar to the process described above in conjunction with the conventional technology, a process for recording new data to the recording medium 11 is performed by the data processing section 12, the working memory 13, the cluster data processing section 14, and the regular file index processing section 15.

The data recording apparatus according to the present embodiment is characterized by a process for updating data, which is already recorded in the recording medium 11, by addition or overwriting.

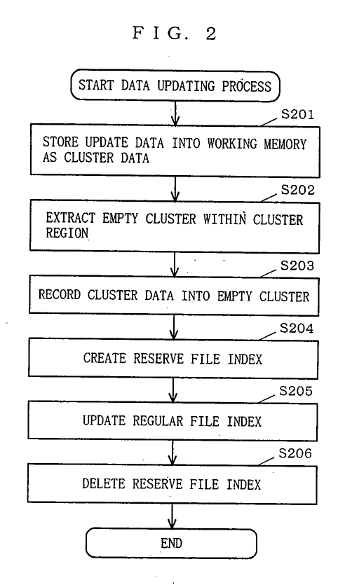

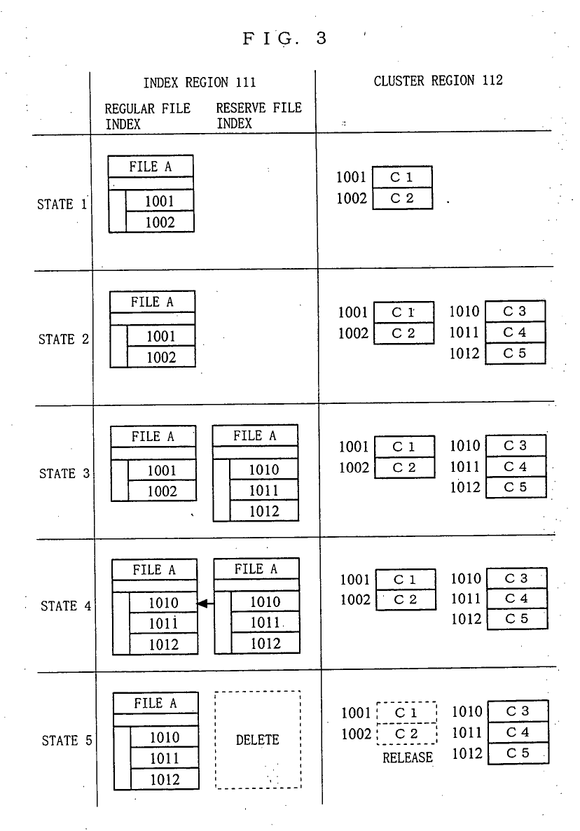

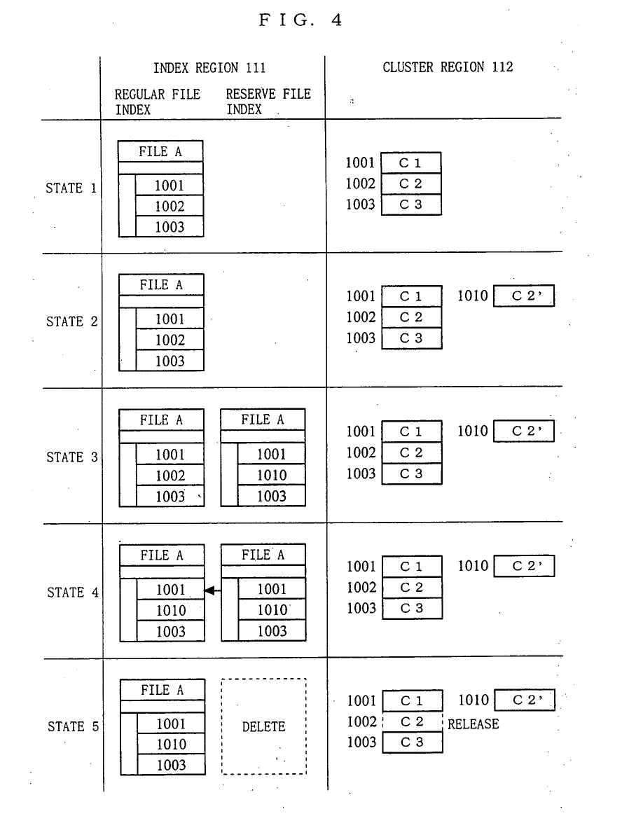

Hereinbelow, a data recording method for use in data updating performed by the data recording apparatus according to the present embodiment will be described with reference to FIGS. 2 to 4. FIG. 2 is a flowchart illustrating a procedure of a process for updating cluster data and a file index. FIGS. 3 and 4 are diagrams each illustrating a specific example of the procedure of the updating process of FIG. 2.

Upon receipt of new data (hereinafter, referred to as the “update data”) for updating data contained in a file which is already recorded in the recording medium 11, the data processing section 12 stores the update data as one cluster data in a unit of a cluster into the working memory 13 or divides the update data into a plurality of cluster data in units of clusters and stores the plurality of cluster data into the working memory 13 (step S201). When the one cluster data/the plurality of cluster data is/are stored in the working memory 13, the cluster data processing section 14 searches the cluster region 112 of the. recording medium 11 and extracts an empty cluster therefrom (step S202). Next, the cluster data processing section 14 reads the cluster data from the working memory 13 and sequentially records the read cluster data into the empty cluster extracted from the recording medium 11 (step S203).

When recording of all the cluster data is completed, the reserve file index processing section 16 creates a new reserve file index, in which information about cluster locations and the order of the cluster data recorded by the cluster data processing section 14 is recorded as cluster arrangement information, within the index region 111 of the recording medium 11 (step S204) . After the reserve file index is created, the regular file index processing section 15 searches a regular file index corresponding to pre-updated data, which is already created within the index region 111, and updates the regular file index such that the contents thereof are replaced with the contents of the reserve file index (step S205). When the contents of the regular file index are updated, the reserve file index processing section 16 deletes the reserve file index from the index region 111 of the recording medium 11 (step S206).

In this manner, the data updating process is completed.

The above procedure of the updating process will now be described in further detail with reference to FIG. 3. Here, consider a case where data A containing cluster data C1 and C2 is already recorded as file A in the recording medium 11 (state 1) and data A is updated to new data A′ containing cluster data C3 to C5.

When the data updating process is started, firstly, the cluster data C3 to C5 in data A′ are recorded into empty clusters 1010 to 1012, respectively, within the cluster region 112 (state 2). Then, a reserve file index in which respective cluster locations of the recorded cluster data C3 to C5 are described is created (state 3). In this case, data is only updated, and therefore a file name and attribute information described in the reserve file index are the same as those described in the regular file index. Next, the contents of the regular file index are rewritten. Specifically, clusters 1001 and 1002 of the cluster arrangement information are rewritten into clusters 1010 to 1012 of the cluster arrangement information contained in the reserve file index (state 4). Lastly, the reserve file index is deleted (step 5). Simultaneously with the deletion, clusters 1001 and 1002 of the cluster region 112 are released.

By implementing the data updating process, it becomes possible to read either pre- or post-updated data as in a manner described below even when a trouble such as power disconnection is caused at any time.

Even in the case where a trouble is caused during the transition from states 1 to 2 (step S203 of FIG. 2) and data A′ (any one of cluster data C3 to C5) is corrupted, it is possible to read pre-updated data A based on the regular file index. Further, even in the case where a trouble is caused during the transition from states 2 to 3 (step S204 of FIG. 2) and a reserve file index for data A′ is corrupted, it is possible to read the pre-updated data A based on the regular file index. Furthermore, even in the case where a trouble is caused during the transition from states 3 to 4 (step S205 of FIG. 2) and a regular file index for data A is corrupted, it is possible to read post-updated data A′ by using the reserve file index therefor. In such a case, a restoring process which will be described later is required. Further still even in the case where a trouble is caused during the transition from states 4 to 5 (step S206 of FIG. 2) and the reserve file index for data A′ is corrupted (incomplete deletion), it is possible to read the post-updated data A′ based on the regular file index.

In a file system, a starting process referred to as “Open” is generally performed when an application program or the like implements file processing. In the starting process, a regular file index for a file to be accessed is read onto a prescribed RAM. The reserve file index as described above is initially created in the RAM by using the read regular file index. Then, the created reserve file index is recorded to the recording medium 11 on a suitable timing and used for updating the regular file index. Even if a trouble is caused during the Open process, only a file index/file indices in the RAM is/are corrupted. Accordingly, no problem would be caused.

The example illustrated in FIG. 3 has been described with respect to the case where the entire new data A′ is recorded to the recording medium 11. In the case where only part of cluster data contained in the existing data A is updated, the updating process may be performed in the following manner.

Next, referring to FIG. 4, consider a case where data A containing cluster data C1 to C3 is already recorded as file A in the recording medium 11 (state 1) and data A is updated to new data A′ containing cluster data C1, C2′, and C3.

When a data updating process is started, firstly, only cluster data C2′, which requires updating, among other cluster data in data A′ is recorded into an empty cluster 1010 within the cluster region 112 (state 2). Then, a reserve file index in which respective cluster locations of the recorded cluster data C2′ and other cluster data C1 and C3 are described is created (state 3). In this case, data is only updated, and therefore a file name and attribute information described in the reserve file index are the same as those described in the regular file index. Next, the contents of the regular file index are rewritten. Specifically, clusters 1001 to 1003 of the cluster arrangement information are rewritten into clusters 1001, 1010, and 1003 of the cluster arrangement information contained in the reserve file index (state 4). Lastly, the reserve file index is deleted (step 5) Simultaneously with the deletion, cluster 1002 of the cluster region 112 is released.

As described above, in the case where a trouble is caused during an operation for updating the regular file index or during an operation for deleting the reserve file index after the reserve file index is created, only one of these file indices remains. Thus, in such a case, two file indices having the same file name do not exist at the same time. However, in the case where a trouble is caused at the completion of state 3 or 4, two file indices having the same file name would exist at the same time. In the case where only the reserve file index remains, it is necessary to recreate a regular file index for a file to be accessed. Accordingly, in such a case, it is necessary to restore the file index, which has been brought into an abnormal state by the occurrence of the trouble, to a normal state.

Next, a process for restoring a file index will be described.

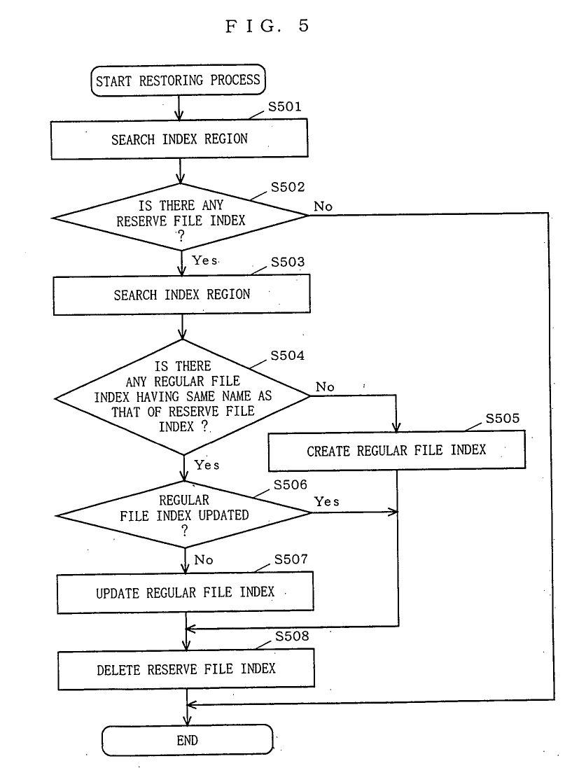

FIG. 5 is a flowchart illustrating a procedure of a process for restoring a file index.

When the data recording apparatus is brought into a state of normal operation by, for example, turning the power on, the file index searching section 18 searches the index region 111 of the recording medium 11 to check whether or not a reserve file index is recorded therein (step S501) . If no reserve file index is recorded (No at step S502), for example, it is determined that the data updating process has been normally completed and a file index restoring process is not required. Accordingly, the procedure is ended. If the reserve file index is recorded (Yes at step S502), the file index searching section 18 further searches the index region 111 of the recording medium 11 to check whether or not there is a regular file index having the same name as that of the reserve file index (step S503).

If there is no regular file index having the same name (No at step S504), the restoring process control section 17 instructs the regular file index processing section 15 to create a regular file index having the same contents as those of the reserve file index within the index region 111 of the recording medium 11 (step S505) . Thereafter, the restoring process control section 17 instructs the reserve file index processing section 16 to delete the reserve file index (step S508) . On the other hand, if there is a regular file index having the same name (Yes at step S504), the restoring process control section 17 determines whether or not the contents of the regular file index has already been updated (step S506) . The determination can be performed by checking the contents of the regular file index against the contents of the reserve file index.

If the contents of the regular file index have not been updated yet (No at step S506), the restoring process control section 17 instructs the regular file index processing section 15 to update the contents of the regular file index to the contents of the reserve file index (step S507). Thereafter, the restoring process control section 17 instructs the reserve file index processing section 16 to delete the reserve file index (step S508). If the contents of the regular file index have already been updated (Yes at step S506), the restoring process control section 17 instructs the reserve file index processing section 16 to delete the reserve file index (step S508).

In this manner, the file index restoring process is performed after trouble recovery, and therefore it is possible to read data from a file without any problems even on the next access after the trouble.

In the case where a trouble is caused during the above-described file index restoring process illustrated in FIG. 5, the same restoring process may be performed once again.

As described above, in the data recording apparatus and method according to an embodiment of the present invention, firstly, post-updated cluster data and a reserve file index therefor are recorded, and thereafter the regular file index is updated. A process for restoring a file index which is in a specific state is implemented after trouble recovery.

Thus, even if a trouble such as power disconnection is caused during a data updating process, it is possible to always keep consistency between the file index and cluster data, thereby avoiding a situation in which data cannot be read. Further, the reserve file index is deleted after the regular file index is updated, and therefore it is possible to use a recording medium having a smaller capacity as compared to the conventional apparatus which redundantly records a backup file. Furthermore, the file index restoring process only includes up to two steps, i.e., the step of creating or updating a regular file index and the step of deleting a reserve file index, and therefore it is possible to quickly restore a file index.

In the above-described embodiment, the case where the data recording apparatus and method of the present invention are applied to a file system, in which a single file is managed by using a single regular file index, has been described. However, it is also possible to apply the data recording apparatus and method of the present invention to a file system in which a single file is managed by using a plurality of regular file indices which are linked to each other. In such a case, similar effects can be achieved by creating a reserve file index for a regular file index associated with updated data.

Further, the data recording apparatus and method of the present invention are effective in various file systems, such as UNIX, LINUX, etc., having file management information corresponding to a file index, and is not limited to the file system using a file index described in the above embodiment.

While the invention has been described in detail, the foregoing description is in all aspects illustrative and not restrictive. It is understood that numerous other modifications and variations can be devised without departing from the scope of the invention.

1. A data recording apparatus for recording data to a recording medium by using a file containing one or more cluster data in prescribed recording units, and at least one file index in which at least a file name, and locations and an order of cluster data recorded on the recording medium are described, the apparatus comprising:
a cluster data recording processing section for recording the data into an empty region within the recording medium in units of the cluster data;
a regular file index recording processing section for creating a file index for the data recorded by the cluster data recording processing section as a regular file index and recording the regular file index to the recording medium, the data being new data contained in a new file;
a reserve file index recording processing section for creating another file index for the data recorded by the cluster data recording processing section as a reserve file index and recording the reserve file index to the recording medium, the data being update data for updating data contained in an existing file,
a regular file index update processing section for searching, after the reserve file index is recorded by the reserve file index recording processing section, the recording medium for an existing regular file index having the same file name as that of the reserve file index, and updating contents of the regular file index, which has been searched for, to contents of the reserve file index; and
a reserve file index delete processing section for deleting the reserve file index from the recording medium after the contents of the regular file index is updated by the regular file index update processing section.

2. The data recording apparatus according to claim 1, further comprising:
an index searching section for searching through the at least one file index recorded in the recording medium at a startup of the apparatus to detect whether or not the reserve file index is present; and
a restoring process control section for instructing the regular file index update processing section to update the contents of the existing regular file index to the contents of the reserve file index based on a determination by the index searching section that the reserve file index is present, and thereafter instructing the reserve file index delete processing section to delete the reserve file index.

3. A data recording method for recording data to a recording medium by using a file containing one or more cluster data in prescribed recording units, and at least one file index in which at least a file name, and locations and an order of cluster data recorded on the recording medium are described, the method comprising:
a first recording step of recording the data into an empty region within the recording medium in units of the cluster data;
a second recording step of creating a file index for the data recorded to the recording medium at the first recording step as a regular file index and recording the regular file index to the recording medium, the data being new data contained in a new file;
a third recording step of creating another file index for the data recorded to the recording medium at the first recording step as a reserve file index and recording the reserve file index to the recording medium, the data being update data for updating data contained in an existing file,
a first updating step of searching, after the third recording step, the recording medium for an existing regular file index having the same file name as that of the reserve file index, and updating contents of the regular file index, which has been searched for, to contents of the reserve file index; and
a first deleting step of deleting the reserve file index from the recording medium after the first updating step.

4. The data recording method according to claim 3, further comprising:
a detecting step of searching through the at least one file index recorded in the recording medium at the beginning of the method to detect whether or not the reserve file index is present;
a second updating step of updating the contents of the existing regular file index to the contents of the reserve file index based on a determination by the detecting step that the reserve file index is present; and
a second deleting step of deleting the reserve file index from the recording medium after the second updating step.

5. A program implemented by a data recording apparatus for recording data to a recording medium by using a file containing one or more cluster data in prescribed recording units, and at least one file index in which at least a file name, and locations and an order of cluster data recorded on the recording medium are described, the program comprising:
a first recording step of recording the data into an empty region within the recording medium in units of the cluster data;
a second recording step of creating a file index for the data recorded to the recording medium at the first recording step as a regular file index and recording the regular file index to the recording medium, the data being new data contained in a new file;
a third recording step of creating another file index for the data recorded to the recording medium at the first recording step as a reserve file index and recording the reserve file index to the recording medium, the data being update data for updating data contained in an existing file,
a first updating step of searching, after the third recording step, the recording medium for an existing regular file index having the same file name as that of the reserve file index, and updating contents of the regular file index, which has been searched for, to contents of the reserve file index; and
a first deleting step of deleting the reserve file index from the recording medium after the first updating step.

6. The program according to claim 5, further comprising:
a detecting step of searching through the at least one file index recorded in the recording medium at the beginning of the program to detect whether or not the reserve file index is present;
a second updating step of updating the contents of the existing regular file index to the contents of the reserve file index based on a determination by the detecting step that the reserve file index is present; and
a second deleting step of deleting the reserve file index from the recording medium after the second updating step.

7. A program recording medium having a program recorded therein, the program being implemented by a data recording apparatus for recording data to a recording medium by using a file containing one or more cluster data in prescribed recording units, and at least one file index in which at least a file name, and. locations and an order of cluster data recorded on the recording medium are described, the program comprising:
a first recording step of recording the data into an empty region within the recording medium in units of the cluster data;
a second recording step of creating a file index for the data recorded to the recording medium at the first recording step as a regular file index and recording the regular file index to the recording medium, the data being new data contained in a new file;
a third recording step of creating another file index for the data recorded to the recording medium at the first recording step as a reserve file index and recording the reserve file index to the recording medium, the data being update data for updating data contained in an existing file,
a first updating step of searching, after the third recording step, the recording medium for an existing regular file index having the same file name as that of the reserve file index, and updating contents of the regular file index, which has been searched for, to contents of the reserve file index; and
a first deleting step of deleting the reserve file index from the recording medium after the first updating step.

8. The program recording medium according to claim 7, wherein the program further comprises:
a detecting step of searching through the at least one file index recorded in the recording medium at the beginning of the program to detect whether or not the reserve file index is present;
a second updating step of updating the contents of the existing regular file index to the contents of the reserve file index based on a determination by the detecting step that the reserve file index is present; and
a second deleting step of deleting the reserve file index from the recording medium after the second updating step.
